(19) United States
(12) Patent Application Publication
(10) Pub. No.: US 2010/0057527 A1
(43) Pub. Date: Mar. 4, 2010

(54) SYSTEM AND METHOD FOR PERSONALIZED ACTION BASED ON A COMPARISON OF DELIVERED CONTENT WITH A CONTENT FINGERPRINT DATABASE

(75) Inventor: Arnaud Robert, Burbank, CA (US)

Correspondence Address: DISNEY ENTERPRISES, INC.;C/O KNOBBE, MARTENS, OLSON & BEAR, LLP, 2040 MAIN STREET, 14TH FLOOR, IRVINE, CA, 92614, US

(73) Assignee: Disney Enterprises, Inc., Burbank, CA (US)

(21) Appl. No.: 12/201,981

(22) Filed: Aug. 29, 2008

(51) Int. Cl. G06Q 30/00; G06F 7/20; G06F 17/30

(52) U.S. Cl. 705/10; 705/1; 707/E17.014; 705/14.66

(57) ABSTRACT

Methods and apparatuses that include fingerprint technology on a media device with a fine level of granularity, to recognize or identify a content item based on a fingerprint or a portion of a content item based on a fingerprint unit, of a content item that is currently being viewed, and takes an action based on that identification.

### BACKGROUND OF THE INVENTION

1. Field of the Invention

The present application relates in certain embodiments to methods and apparatuses using digital fingerprinting technology to recognize or identify at least a specific portion of a content item, then take a predetermined and/or customized action based on that recognition.

### DESCRIPTION OF THE RELATED ART

A non-fingerprinting method such as an electronic programming guide (EPG), like TV Guide, identifies a content item based on a predicted timeslot for what is supposed to be airing on a channel at a specific time. Based on this prediction, a predetermined action can be taken at a specific time. However, there are many drawbacks to this prediction type method. For example, identifying a movie or show via prediction can be incorrect if an earlier show or sporting event runs longer or shorter than estimated, and therefore does not allow for a customized action to be taken based on the content item actually being viewed. Also, the EPG identification does not have a fine level of granularity, in that EPG can only identify the entire content item, and not a particular scene or portion of the content item.

Another drawback to a prediction type method, is that it does not identify recorded content items, such a DVD or DVR recorded file. Once again, the prediction method is unable to accurately indicate what is being watched, and therefore is unable to offer a customized and/or predetermined action. There exists a need in the art for a system or method that uses fingerprinting technology to recognize a movie or show actually being viewed based on a portion of the content, so that a customized action can be taken.

### SUMMARY OF THE INVENTION

One embodiment is a system for displaying media, the system comprising a media presentation device for receiving and rendering a content item, a content fingerprint database that is communicatively coupled to the media presentation device for storing a plurality of fingerprint units for a plurality of content items, and a fingerprint unit detection module that is communicatively coupled to the media presentation device and is configured to compute a fingerprint unit corresponding to the portion of the content item being rendered and determining whether the computed fingerprint unit matches one of the fingerprint units on the content fingerprint database, wherein the media presentation device takes an action subsequent to determining a match.

In another embodiment, there is a method for displaying media, the method comprising receiving and rendering a content item on a media presentation device, storing a plurality of fingerprint units on a content fingerprint database for a plurality of content items, and computing a fingerprint unit corresponding to a portion of the content item being rendered and determining whether the computed fingerprint unit matches one of the fingerprint units on the content fingerprint database, wherein the media presentation device takes an action subsequent to determining a match.

In another embodiment, there is a method for displaying media, the method comprising receiving and rendering a content item on a media presentation device, storing a plurality of fingerprints on a content fingerprint database for a plurality of content items, computing a fingerprint corresponding to the content item being rendered and determining whether the computed fingerprint matches one of the fingerprints on the content fingerprint database, and modifying a profile of a user subsequent to determining a match.

In another embodiment, there is a system for displaying media, the system comprising a media presentation device for receiving and rendering a content item, a content fingerprint database that is communicatively coupled to the media presentation device for storing a plurality of fingerprint units for a plurality of content items, a fingerprint unit detection module that is communicatively coupled to the media presentation device and is configured to compute a fingerprint unit corresponding to the portion of the content item being rendered and determining whether the computed fingerprint unit matches one of the fingerprint units on the content fingerprint database, and a profile of a user communicatively coupled to the media presentation, wherein the profile is modified subsequent to determining a match.

In another embodiment, there is a system for displaying media, the system comprising presentation means for receiving and rendering a content item, storage means that is communicatively coupled to the presentation means, for storing a plurality of fingerprint units for a plurality of content items, and detection means that is communicatively coupled to the presentation means, for computing a fingerprint unit corresponding to the portion of the content item being rendered and determining whether the computed fingerprint unit matches one of the fingerprint units in the storage means, wherein the presentation means takes an action subsequent to determining a match.

### BRIEF DESCRIPTION OF THE DRAWINGS

FIG. 1 illustrates a perspective view of a media presentation containing receiving devices, media presentation devices, and content items.

FIG. 2 illustrates a side view of a media presentation device.

FIG. 3 illustrates a side view of modules located inside a media presentation device.

FIG. 4 illustrates a perspective view of modules coupled to a media presentation device through a network.

FIG. 5A and FIG. 5B illustrate top views of embodiments of content items.

FIG. 6 illustrates a table that lists information stored in a content fingerprint database.

FIG. 7 illustrates a table that lists information stored in a user's profile.

FIG. 8 illustrates a process of displaying an offering based on a fingerprint unit.

FIG. 9 illustrates a process of displaying an offering based on a user's profile.

### DETAILED DESCRIPTION OF CERTAIN EMBODIMENTS

This detailed description is directed to certain specific embodiments of the invention. However, the invention can be embodied in a multitude of different ways. In this description, reference is made to the drawings wherein like parts are designated with like numerals throughout. More particularly, it is contemplated that the embodiments may be implemented in or associated with a variety of electronic devices such as, but not limited to, cable set up top boxes, DVR, televisions, and computers.

In some embodiments, methods and apparatuses that use fingerprinting technology on a media device with a fine level of granularity to recognize or identify a content item based on a “fingerprint”, or a portion of a content item based on a “fingerprint unit”, of a content item that is currently being viewed, and take a predetermined and/or customized action based on that identification. As used herein, a fingerprint includes data derived from the content item or from metadata about a content item, and for practical purposes is virtually unique, and thus can be used to identify the content item. A fingerprint is considered virtually unique because a fingerprint of one content item can be distinguished from fingerprints of almost all other content items. A fingerprint unit includes data derived from a content item or from metadata about a content item, and again is virtually unique, and identifies a component of the content item.

As a result, a digital fingerprint can be thought of as the DNA of the content item. A digital fingerprint can be used to identify attributes of the content item, such as the owner of the file, or name of the show or movie based on the entire content item. In contrast to digital fingerprints, a digital fingerprint unit can recognize be used to identify a specific portion of the content item with a fine level of granularity. A digital fingerprint unit can be used to recognize a scene of a movie, perceptual information from a scene, the last minute of a television show, etc. The identification or recognition process can be based on comparing the fingerprint or fingerprint unit derived from the content or the content item (or metadata or metadata item) with a database of pre-computed fingerprints or fingerprints units. After a fingerprint or fingerprint unit is recognized, a customized or predetermined action can be taken. A predetermined action can include displaying a customized offering with a business rationale. A predetermined action can include building a user profile based on demographic information learned about the user or users based on what the users actually watch. A predetermined action can include, in the case where the identification or recognition process yielded no result, the addition of the fingerprint computed from the content or the content unit to the database of fingerprints. The action includes predetermined actions and dynamically determined actions. Dynamically determined actions include actions determined on the fly. An offering can be more valuable and customized as more is known about the user, or if the specific location in the content item is known.

In these embodiments, a content item can include any audio, video, audio-video file, or games. A content item can be an electronic media file. Other examples include cable or satellite television, DVDs, CDs, MP3s, videos played on a computer, computer games, a prerecorded show from a DVR, etc. Each content item's fingerprint is separate from all other content item's fingerprints.

In one embodiment, there is a system with a media presentation device, receiving device, and content item. The media presentation device may include a content fingerprint database for storing a listing of pre-computed fingerprint units. The media presentation device may also include a fingerprint unit detection unit for detecting a digital fingerprint or a digital fingerprint unit of a content item that is being rendered. The media presentation device may also include a user profile for storing content viewed by the user and the related demographics or preferences. The media presentation device is coupled to a receiving device which displays the content item.

In one embodiment, the media presentation device 100 identifies a portion of a content item by a digital fingerprint unit of the content item, and then a customized offering can be displayed based on the content of the portion of the content item that is currently being watched. For example, in one embodiment, the last scene of a movie can be recognized based on its corresponding fingerprint unit, and then an advertisement for a sequel to that movie then can be displayed on the screen. In another embodiment, the media presentation device 100 identifies the entire content item by its digital fingerprint, and then a user profile can be built over time based on the content that has been viewed. For example, a name of a movie can be recognized based on its corresponding fingerprint, then a user profile can be built containing the content item and content item's corresponding demographic information.

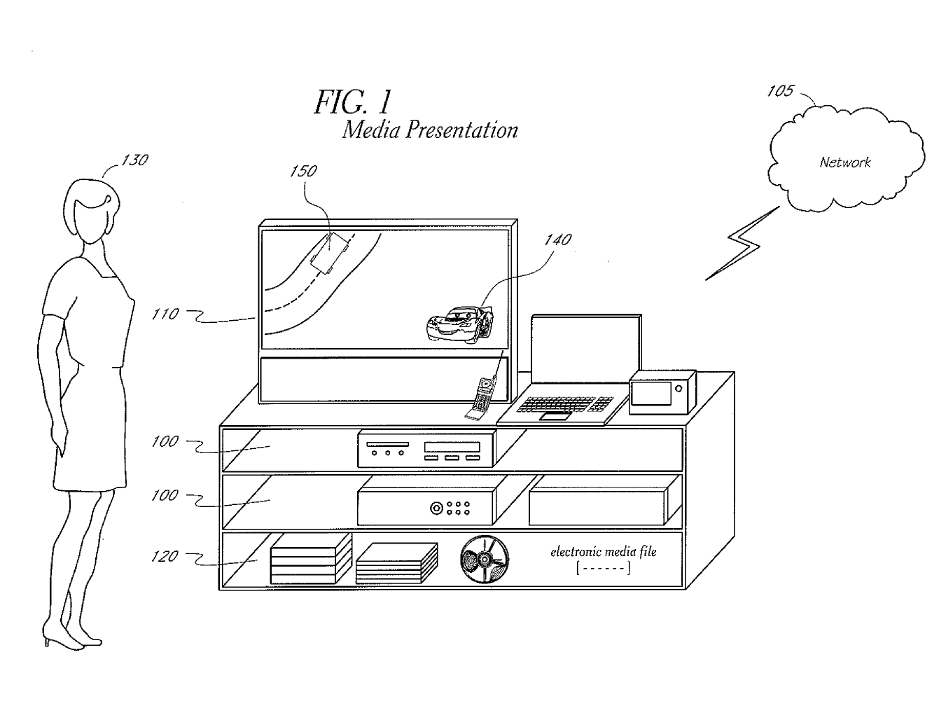

FIG. 1 illustrates a perspective view of a media presentation containing receiving devices 110, media presentation devices 100, content items 120, user 130, offering 140, and perceptual data 150 attached to network 105. Receiving devices 110, are used to display content items so that the content can be viewed by user 130. As shown in FIG. 1, receiving devices 110 include: a television display, a computer display, a display on a cell phone, and a display on a portable video player. Receiving devices are often connected to a media presentation device 100, which are used to receive and render a content item. Thus, media presentation device 100 provides one presentation means for receiving and rendering a content item. As shown in FIG. 1, exemplary media presentation devices include: a DVD/VHS player, a DVR, and cable set up top box.

It is to be recognized that functions of various components of the system described herein are merely illustrative. In particular, various functions described with reference to one or more components may be combined into a single component. For example, in one embodiment, laptops contain both a receiving device (i.e., display screen) for displaying a content item and a presentation device (e.g., DVD drive) for playing the content item. Other embodiments may include any other suitable distribution of the functions described herein.

FIG. 1 also illustrates multiple types of content items 120, such as VHS tapes, DVDs CDs, and electronic media files. Content items 120 include content watched in real time, such as cable television, and content not watched in real time, such as television programs stored on a DVR. A user 130 is illustrated watching a presentation on a display.

On the television display of receiving device 110, FIG. 1 illustrates an offering 140 of Lightning McQueen in a corner of the screen. Offering 140 is presented in this case when a car drives by, where the car is perceptual data 150. Offerings 140 include any customized advertisement for any business purpose or commercial rationale. Examples of offerings 140 include advertising to promote a company, to buy a DVD, teasers for a sequel, promotional clips, merchandizing, trailers, etc. Perceptual information or data 150 includes any data on a display that a viewer can see. Examples of perceptual data 150 include the main element of a scene, such as a sunset, a car going by, a house, or trees.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

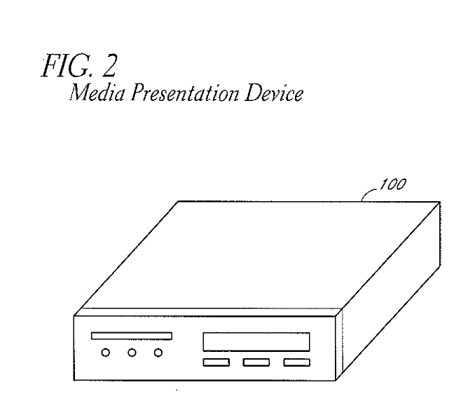

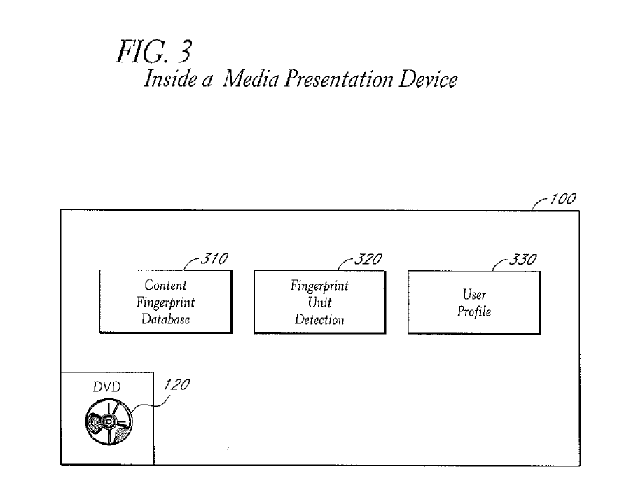

FIG. 2 illustrates a closer view of the media presentation device 100 from FIG. 1. Here, a DVD/VHS player is illustrated. Media presentation device 100 can include any player that receives or plays content items. Examples of media presentation device 100 include a cable or satellite set up top box, CPU, DVD/VHS player, DVR, etc. The media presentation device 100 can store electronic modules, such as the modules shown in FIG. 3.

FIG. 3 illustrates the inside of the media presentation device 100 shown in FIGS. 1 and 2, including electronic modules inside or coupled to this device. These modules allow for identification of content items currently being watched so that a predetermined action based on that identification can be taken. In this embodiment, media presentation device 100 includes a content fingerprint database 310, fingerprint unit detection 320, user profile 330, and content item 120.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In some embodiments, a predetermined action is based on a combination of both the detection of a match by the fingerprint unit detection database 320 and data in the user profile 330. For example, an offering can be based on information known about the user from the profile 330, and information known about the content item 120 from the fingerprint unit. In another embodiment, the predetermined action is based on only one of database 320 and profile 330.

The content fingerprint database 310 can include a module that stores fingerprint units for content items and a corresponding customized offering. Thus, content fingerprint database 310 provides one storage means for storing a plurality of pre-computed fingerprint units for a plurality of content items. In one embodiment, a central service or location (not shown) can update or “push” fingerprint values into the fingerprint database 310. These updates can occur periodically, such as based on a time interval or opportunistically. For example, the updates can be based on the popularity of a particular content for a given week or other time period, or based on other triggers related to the content or the usage of such content.

Furthermore, the media presentation device 100 can update the content fingerprint database 310 when a fingerprint of a content item being render is not recognized (i.e., not pre-computed). In this embodiment, when a user replays the same content item, the pre-computed fingerprint is now stored in the content fingerprint database 310. Furthermore, after the content fingerprint database 310 is updated, the media presentation device 100 can update other computing devices, such as the central service. The fingerprint unit detection 320 is a module that identifies the specific portion of the content item 120 that is currently being watched by computing a fingerprint and determining if there is a match on the content fingerprint database 310. Thus, fingerprint unit detection 320 provides one detection means for computing a fingerprint unit corresponding to the portion of the content item being rendered and determining whether the computed fingerprint unit matches one of the pre-computed fingerprint units in the content fingerprint database 310. User profile 330 can store a table with content items that have been watched, the corresponding demographic information, and when the content item was watched (e.g., date, day, time). The media presentation device 100 can use this information to determine a customized and predetermined action.

The user can include one person, a group of people, or a family that use media presentation device 100. The user profile can store one profile for all users, or individual profiles for individual users. The user profile 330 is useful in determining the preferences and demographics of the one or more people who use media presentation device 100. The user profile can be built up over time to more accurately understand the user's preferences or demographics as the user watches more content items, or the profile can store only a predetermined amount of time or data. The profile can be used to select a predetermined action that is relevant to the preferences or demographics of the users of the presentation device.

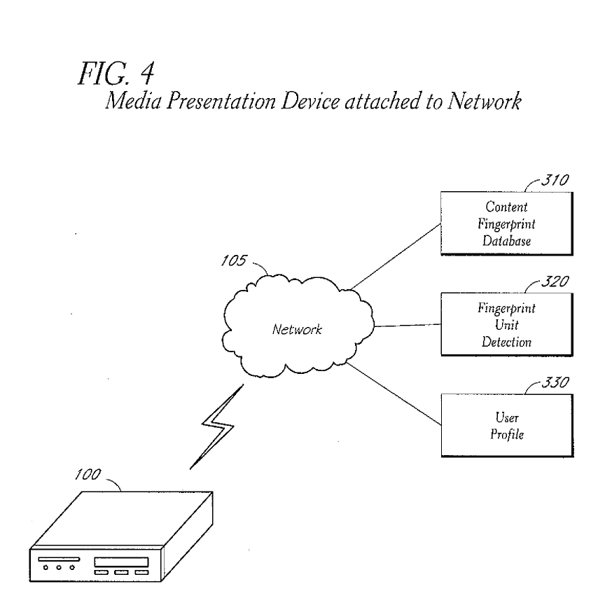

As an alternative to FIG. 3, FIG. 4 illustrates media presentation device 100 connected to modules 310, 320, and 330 via a network 105. Like FIG. 3, content fingerprint database 310 can store fingerprint units, fingerprint unit detection 320 can identify the specific portion of the content item 120, and user profile 330 can store watched content items. Even though this figure shows modules 310-330 connected through the network 105, in one embodiment just the user profile 330 and the content fingerprint database 310 are connected through the network 105, and the remaining module or modules are coupled to the media presentation device 100. In another embodiment, only one of the user profile 330 and the content fingerprint database 310 is connected through the network 105.

The network 105 may include one or more of the Internet, a server, a cable head-end or other video on demand service, or any other suitable network. The media presentation device 100 may communicate with the network 105 via any suitable network interface including, for example, Ethernet, a wireless (WiFi) Ethernet, and/or Bluetooth. The network interface may further include a DSL or cable modem connection.

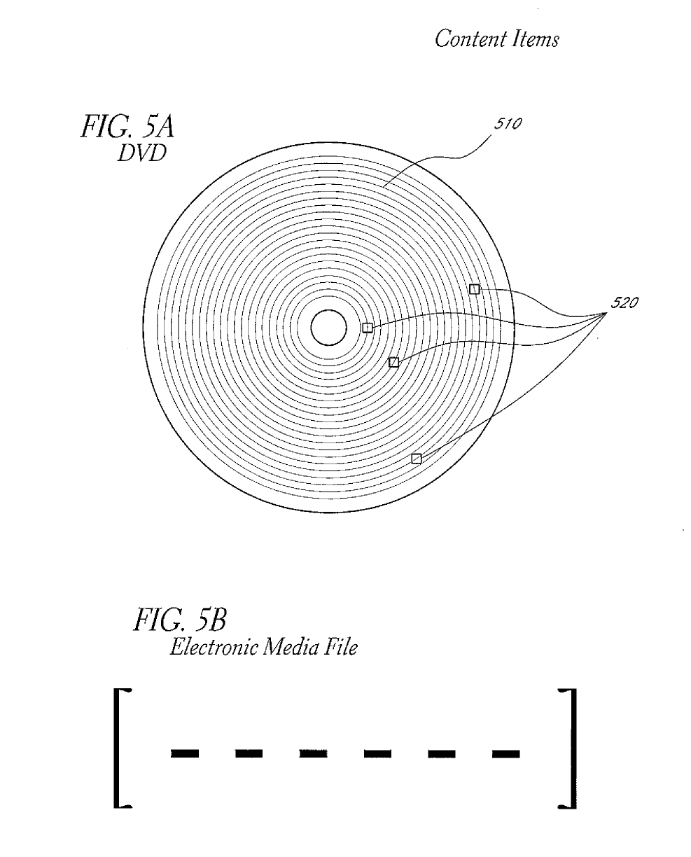

FIG. 5A and FIG. 5B are drawings of exemplary content items 120 shown in FIG. 1. In FIG. 5A, the content item is a DVD, however as discussed above, other content items can be used to store an audio, visual, audio-visual display, or game. FIG. 5A illustrates a difference between a digital fingerprint 510 and a digital fingerprint unit 520. In one embodiment, a content item 120 has only one digital fingerprint 510, and fingerprint 510 is unique from fingerprints of other types of content items. In FIG. 5B, the content item is an electronic media file. In this embodiment, the fingerprint and fingerprint unit are both computed from data in the electronic media file.

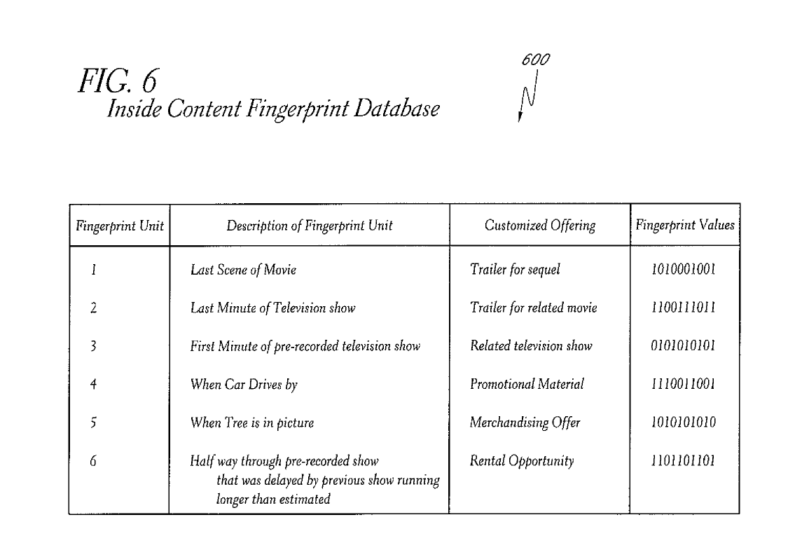

FIG. 6 illustrates an exemplary fingerprint database table 600 that lists information that can be stored in the content fingerprint database 310 in the media presentation device 100 or connected through a network 105 as shown in FIGS. 3 and 4. In one embodiment, media presentation device 100 builds table 600 by compiling pre-computed fingerprint units that represent portions of content items, along with associated customized offerings 140. Media presentation device 100 can select offerings 140 from database 600 if the pre-computed fingerprint unit matches the fingerprint unit 520 of the content item 120 currently being watched. In one embodiment, the music or movie industry provides the fingerprint units 520 for content items 120. In other embodiments, a server is used to update table 600 via a network 105. In another embodiment, content items 120 are used to update table 600.

In the first column, this table lists six pre-computed fingerprint units representing portions of a content item. In one embodiment, portions of the content item include descriptions of the fingerprint unit, and instructions how to identify a particular fingerprint unit. The second column lists exemplary descriptions of portions of content items that correspond to fingerprint units. The second column stores information that allow the media presentation device 100 to recognize not only that a specific content item is currently being watched, but recognize the very specific portion of that content item. The third column lists exemplary descriptions of customized offerings 140 corresponding to that fingerprint unit. An offering comprises a program or piece of code that can perform one or more of the exemplary descriptions. A customized offering 140 is a type of predetermined action, and can include an advertisement for any business purpose or commercial rationale. Examples of offerings 140 include advertising to promote a company, to buy a DVD, teasers for a sequel, promotional clips, merchandizing, trailers, etc. For example, in the first row of FIG. 6, when the media presentation device 100 computes a fingerprint unit that indicates that the last scene of a movie is being watched, the media presentation device 100 runs a program which displays a trailer for the sequel to that movie. The fourth column lists exemplary fingerprint values corresponding to the fingerprint units. A fingerprint value, which is illustrated in the fourth column as bits, can represent the actual value of the fingerprint or fingerprint units, represent an encoded form of the value of the fingerprint or fingerprint units, or represent a storage location on the fingerprint database 310 for the fingerprint unit containing the customized offering.

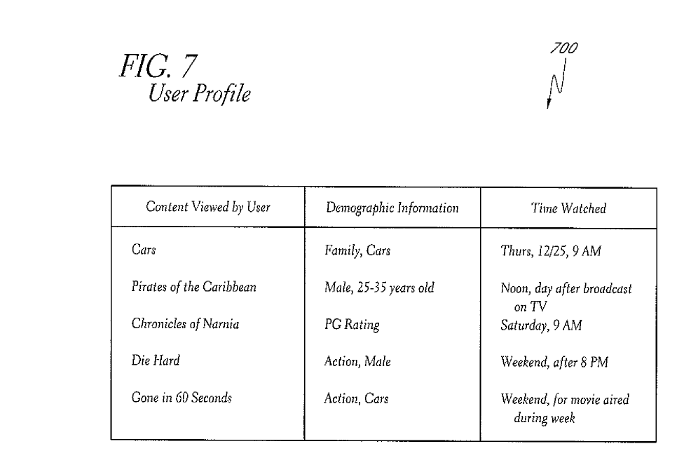

FIG. 7 illustrates an exemplary user profile table 700 that lists information stored in the user's profile 330 shown in FIGS. 3 and 4. Advantageously, the media presentation device 100 can customize offerings 140 based on a user's profile 330. In the first column, user profile table 700 lists five exemplary movies. The second column lists exemplary demographic information corresponding to the five movies. Demographic information can include any stereotypical type of information or preferences of the one or more users of a media presentation device, based on knowledge of the content items watched. Examples of demographic information include user's gender, user's age range, movie genre, date of movie, intended audience, etc. In one embodiment, the media presentation device 100 builds a user profile by identifying the fingerprint 510 of the content item being watched.

The third column indicates what time the content item is watched. Dates can signify holidays, days can signify whether this is a weekday or weekend, and times can signify whether the content item is being watched at night or during the day. In addition, for recorded content items, the user profile can be updated with the time watched versus the time the content originally aired. For example, a user that regularly records a television show on Monday night, and watches it Tuesday morning or afternoon, can reveal significant information about that user. Then, the media presentation device 100 retrieves data from the user profile 330 to provide offerings 140 related to the user's preferences based on the content item actually watched.

The user profile 330 is useful in determining the preferences and demographics of the one or more people who use this presentation device. For example, if the media presentation device 100 usually plays action films, this is an indicator that the user or users are male and from 25-35 years old. However, if the media presentation device 100 is used primarily for PG movies, it is likely that this device is used for family purposes. The user profile 330 can become more accurate over time as the user or viewer watches more content items 120. Based on the content items 120 watched, the user profile 330 can be used to select a predetermined action that is relevant to the demographics or preferences of the user or users of the presentation device 100.

The user profile 330 can be built up over time to more accurately understand the user's preferences or demographics as the user watches more content items, or the profile can store only a predetermined amount of time or data.

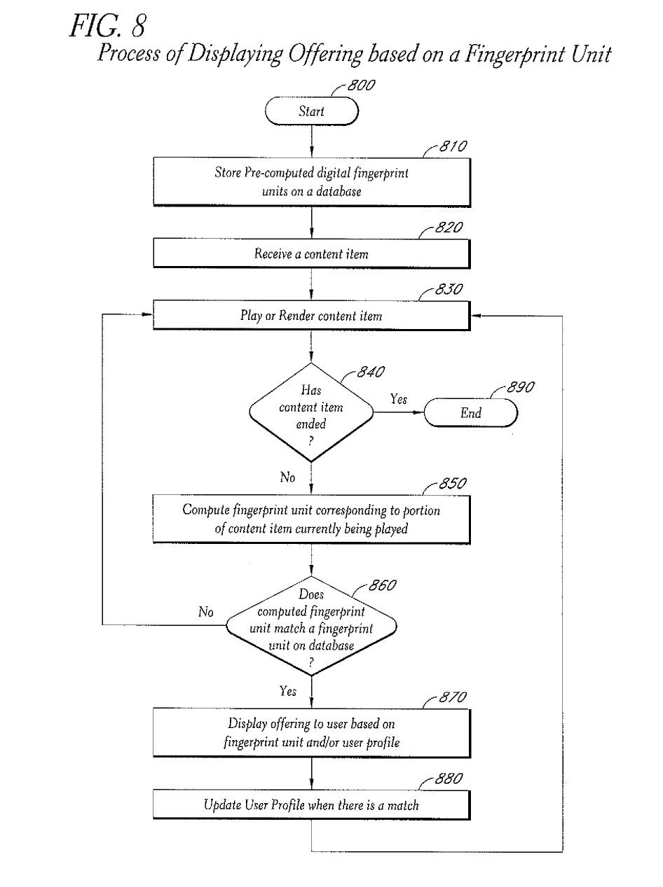

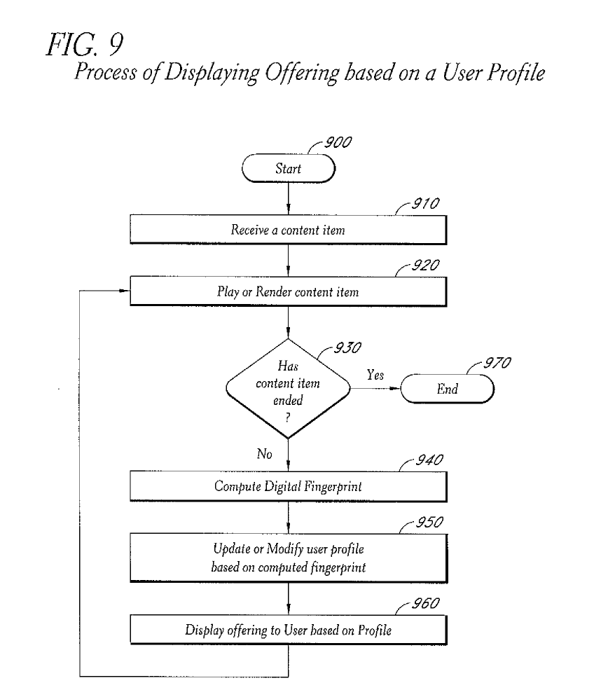

FIGS. 8 and 9 illustrate flow charts covering embodiments of the system discussed in FIGS. 1-7. FIG. 8 illustrates a process of displaying an offering based on a fingerprint unit. The process starts at step 800. At step 810, media presentation device 100 stores pre-computed digital fingerprint units in the content fingerprint database 310. The content fingerprint database 310 can include a module that stores fingerprint units and a corresponding customized offering. By this point in the process, the user 330 has typically turned on the media presentation device 100. Proceeding to step 820, media presentation device 100 receives a content item 120. Sometimes, user 130 physically loads a content item 120 such as a DVD into the media presentation device 100. Alternatively, user 130 can select a live content item 120, or select a pre-recorded content item 120 such as digitally recorded show that is downloaded on the media presentation device 100.

Next, at step 830 the media presentation device 100 plays or renders the content item 120. At decision step 840, the media presentation device 100 determines whether the end of the content item 120 has been reached. If the content item has not reached the end, the media presentation device 100 in step 850 computes a fingerprint unit 520 corresponding to a portion of a content item 120 currently being played. Continuing to decision step 860, the media presentation device 100 determines whether the computer fingerprint unit 520 matches a fingerprint unit on the database 310. If there is a match, then the media presentation device 100 displays an offering to the user 130 on the receiving device 110 based on the fingerprint unit 510 and/or the user profile 330 at step 870. Subsequently, the media presentation device 100 updates the user profile 330 at step 880 when there is a match. Alternatively, if decision step 860 indicates there is no match, the process reverts back to step 830 to continue to play or render the content item 120. When step 840 indicates that the content item 120 has ended, the offerings are no longer displayed as the process ends with step 890.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a mobile station. In the alternative, the processor and the storage medium may reside as discrete components in a mobile station.

FIG. 9 illustrates a process of displaying an offering 140 based on a user's profile 330. The process starts at step 900. By this point in the process, a user 130 has typically turned on the media presentation device 100, and is about to load or select a content item 120. At step 910, the media presentation device 100 receives a content item 120. Proceeding to step 920, the media presentation device 100 plays or renders the content item 120. Next, at decision step 930, the media presentation device 100 determines whether the end of the content item 120 has been reached. If the content item has not reached the end, the media presentation device 100 computes a digital fingerprint 510 at step 940.

Continuing to step 950, the media presentation device 100 updates or modifies the user profile 120 based on the computed fingerprint 510. The profile can be updated with shows and the associates preferences or demographics associated with the shows. The user profile can be built up over time to more accurately understand the user's preferences or demographics as the user watches more content items, or the profile can store only a predetermined amount of time or data.

At step 960, the media presentation device 100 displays an offering to the user based on the profile 330. The user profile 330 is useful in determining the preferences and demographics of the one or more people who use media presentation device 100. The user profile 330 can store one profile for all users, or individual profiles for individual users. Next, the process reverts back to step 920 to continue to play or render the content item 120 using the media presentation device 100. If the media presentation device 100 in step 930 indicates that the content item 120 has reached the end, the offerings are no longer displayed as the process ends with step 970.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for displaying media, the system comprising:
a media presentation device for receiving and rendering a content item;
a content fingerprint database that is communicatively coupled to the media presentation device for storing a plurality of fingerprint units for a plurality of content items; and
a fingerprint unit detection module that is communicatively coupled to the media presentation device and is configured to compute a fingerprint unit corresponding to the portion of the content item being rendered and determining whether the computed fingerprint unit matches one of the fingerprint units on the content fingerprint database, wherein the media presentation device takes an action subsequent to determining a match.

2. The system of claim 1, wherein the action comprises a predetermined action.

3. The system of claim 1, wherein the action comprises a dynamically determined action.

4. The system of claim 2, wherein the predetermined action comprises displaying an offering to a user.

5. The system of claim 4, wherein the offering comprises an advertisement.

6. The system of claim 4, wherein the offering is stored in the content fingerprint database.

7. The system of claim 1, wherein the portion of the content item comprises a scene or a portion of a scene.

8. The system of claim 1, wherein the portion of the content item comprises perceptual information from a scene.

9. The system of claim 8, wherein perceptual information comprises a moving object that is visible to a user.

10. The system of claim 1, wherein at least a portion of the content fingerprint database is located inside the media presentation device.

11. The system of claim 1, wherein at least a portion of the content fingerprint database is located on a network.

12. The system of claim 2, wherein the system that triggers the predetermined action is located on a network at least in part.

13. The system of claim 1, wherein the fingerprint unit detection module is located on a network.

14. The system of claim 1, wherein the media presentation device modifies a profile of a user based on selections by the user, wherein the media presentation device takes a customizing action based on the profile of the user or based a combination of the profile and the matched fingerprint unit.

15. The system of claim 1, wherein the action is based on a time of when a user watches the content item.

16. The system of claim 1, further comprising updating the content fingerprint database to include a fingerprint or fingerprint unit of a content item being rendered subsequent to determining there is not a match.

17. The system of claim 1, further comprising updating the content fingerprint database periodically or opportunistically from a central service.

18. A method for displaying media, the method comprising:
receiving and rendering a content item on a media presentation device;
storing a plurality of fingerprint units on a content fingerprint database for a plurality of content items; and
computing a fingerprint unit corresponding to a portion of the content item being rendered and determining whether the computed fingerprint unit matches one of the fingerprint units on the content fingerprint database, wherein the media presentation device takes an action subsequent to determining a match.

19. The method of claim 18, wherein the action comprises displaying an offering to a user.

20. The method of claim 18, wherein the portion of the content item comprises a scene or a portion of a scene.

21. The method of claim 18, wherein the portion of the content item comprises perceptual information from a scene.

22. The method of claim 18, wherein the content fingerprint database is located outside of the media presentation device.

23. The method of claim 18, further comprising storing data in a user profile, wherein the action is based on a combination of the data in the user profile and the matched fingerprint unit.

24. The method of claim 18, further comprising updating the content fingerprint database with a fingerprint or fingerprint unit of a content item being rendered subsequent to determining there is not a match.

25. The method of claim 18, further comprising updating the content fingerprint database periodically or opportunistically from a central service.

26. A method for displaying media, the method comprising:
receiving and rendering a content item on a media presentation device;
storing a plurality of fingerprints on a content fingerprint database for a plurality of content items;
computing a fingerprint corresponding to the content item being rendered and determining whether the computed fingerprint matches one of the fingerprints on the content fingerprint database; and
modifying a profile of a user subsequent to determining a match.

27. The method of claim 26, further comprising modifying the profile of the user based on selections by the user, wherein the media presentation device takes a customizing action based on the profile of the user.

28. The method of claim 26, further comprising taking a customized action based on both a matched fingerprint unit and the profile of the user.

29. The method of claim 26, further comprising a customizing action of displaying a customized offering to the user.

30. The method of claim 26, wherein the profile of the user comprises demographic information.

31. The method of claim 26, wherein the profile of the user comprises a time of when the user watched the content item.

32. The method of claim 26, further comprising a customized action of selecting an offering for the user based on the demographic information in the profile of the user.

33. The method of claim 26, further comprising updating the content fingerprint database with a fingerprint or fingerprint unit of a content item being rendered subsequent to determining there is not a match.

34. The method of claim 26, further comprising updating the content fingerprint database periodically or opportunistically from a central service.

35. A system for displaying media, the system comprising:
a media presentation device for receiving and rendering a content item;
a content fingerprint database that is communicatively coupled to the media presentation device for storing a plurality of fingerprint units for a plurality of content items;
a fingerprint unit detection module that is communicatively coupled to the media presentation device and is configured to compute a fingerprint unit corresponding to the portion of the content item being rendered and determining whether the computed fingerprint unit matches one of the fingerprint units on the content fingerprint database; and
a profile of a user communicatively coupled to the media presentation, wherein the profile is modified subsequent to determining a match.

36. The system of claim 35, further comprising updating the content fingerprint database periodically or opportunistically from a central service.

37. A system for displaying media, the system comprising:
presentation means for receiving and rendering a content item;
storage means that is communicatively coupled to the presentation means, for storing a plurality of fingerprint units for a plurality of content items; and
detection means that is communicatively coupled to the presentation means, for computing a fingerprint unit corresponding to the portion of the content item being rendered and determining whether the computed fingerprint unit matches one of the fingerprint units in the storage means, wherein the presentation means takes an action subsequent to determining a match.

38. The system of claim 37, wherein the content item is rendered in real time or at the same time as a show is being aired.

39. The system of claim 37, wherein the content item is not rendered at in real time or is played after being recorded.

40. The system of claim 37, further comprising updating the storage means periodically or opportunistically from a central service.
